(19) United States
(12) Patent Application Publication
(10) Pub. No.: US 2013/0052504 A1
(43) Pub. Date: Feb. 28, 2013

(54) BATTERY UNIT

(71) Applicants: Norman Neuhold, Graz (AT); Nikolaus Chorinsky, Graz (AT)

(72) Inventors: Norman Neuhold, Graz (AT); Nikolaus Chorinsky, Graz (AT)

(21) Appl. No.: 13/581,167

(22) PCT Filed: Feb. 24, 2011
(86) PCT No.: PCT/AT2011/000090

§ 371 Date: Nov. 13, 2012

(30) Foreign Application Priority Data
Feb. 25, 2010 (AT) A 290/2010

(51) Int. Cl. H01M 2/02; H01M 2/10

(52) U.S. Cl. 429/99; 429/178; 429/96

(57) ABSTRACT

The invention relates to a storage battery unit (1) with a battery cell (2), having a terminal (3), with edges (6) and an outside insulation (5) also enclosing the edges (6). According to the invention it is provided that a non-conducting, elastic element (4) is positioned on the terminal side between the battery cell (2) and the insulation (5), so that the terminal (3) is set back with respect to a level (7) of the elastic element (4), wherein the insulation (5) fixes the elastic element (4). A stable hold of the storage battery unit (1) in a housing is thus achieved with simultaneous mechanical protection of electrical contacts.

The invention relates to a storage battery unit with a battery cell having a terminal, with edges and an outside insulation also enclosing the edges.

A battery cell with encasing insulation for the separation of a positive terminal from a negative terminal is well known. If a battery cell of this known type is positioned in a housing with interior contacts for electrical contacting, with storage battery housing for industrial tools this is chiefly fixed in the housing by electrical contacts, which are arranged on the base and cover of the housing and clamp the battery cell. This results in the disadvantage that the electrical contacts are exposed to mechanical stress, which particularly with tools exposed to strong vibrations, for example, industrial tools, in the course of time can lead to a looser fit of the battery cell in the housing. In the case of a series connection of several battery cells, the faulty contact of an individual battery cell leads to an interruption of the entire electric circuit. In the case of industrial tools, this can lead to a prolonged stoppage of production plants, which is undesirable.

The object of the invention is to eliminate or at least reduce this disadvantage.

This object is attained with a storage battery unit of the type mentioned at the outset in that a non-conducting, elastic element is positioned on the terminal side between the battery cell and the insulation, so that the terminal is set back with respect to a level of the elastic element, wherein the insulation fixes the elastic element.

An advantage achieved with the invention is to be seen in particular in that a stable fixing of the storage battery unit in the housing with simultaneous mechanical protection of the electrical contacts is achieved when a housing cover or a housing base presses directly on the elastic element of the storage battery unit according to the invention and thus fixes it in the housing. The electrical contacts are consequently in contrast to the prior art not required for the mechanical fixing of the battery cell in the housing. With a storage battery unit according to the invention much greater holding forces can be achieved than via the electrical contacts alone. This results in a more stable fit of the storage battery unit in the housing, a damping against mechanical vibrations and a generally more robust coherence with the housing.

Generally with battery cells a separation of terminals takes place near to a terminal-side edge, which is why a deformation of this edge easily can lead to the short circuit of the cell. In this respect a further advantage achieved with the invention lies in that the terminal-side edge of the battery cell is protected from deformation by the elastic element.

Preferably, the elastic element is composed of an elastically deformable plastic, for example, of a silicone.

Typically, the battery cell is embodied in a rotationally symmetrical and elongated manner, wherein a longitudinal axis coincides with a rotation axis. The elastic element is then preferably also embodied in a rotationally symmetrical manner.

In the case of standardized battery cells, one of the terminals is raised and the elastic element is higher than this terminal. The terminal is thereby offset inwards with respect to the storage battery unit, whereby space is made for an electrical contact on the housing cover or housing base.

It has proven useful that an opening in the elastic element is embodied to be slightly larger than the terminal, so that the elastic element cannot slip. Preferably, the elastic element is embodied as a disk for easy production.

According to the advantages of a storage battery unit described above, this is used advantageously in a storage battery set, which comprises a housing and one or more battery cells, wherein the battery cells are arranged in the housing and at least in part are held by at least partially rigid contacts in an electric circuit arranged on a housing cover and on a housing base. A storage battery set of this type is useful in particular for highly loaded industrial tools.

Further features, advantages and effects of the invention are shown from the exemplary embodiment shown below. In the drawing, to which reference is made thereby, they show:

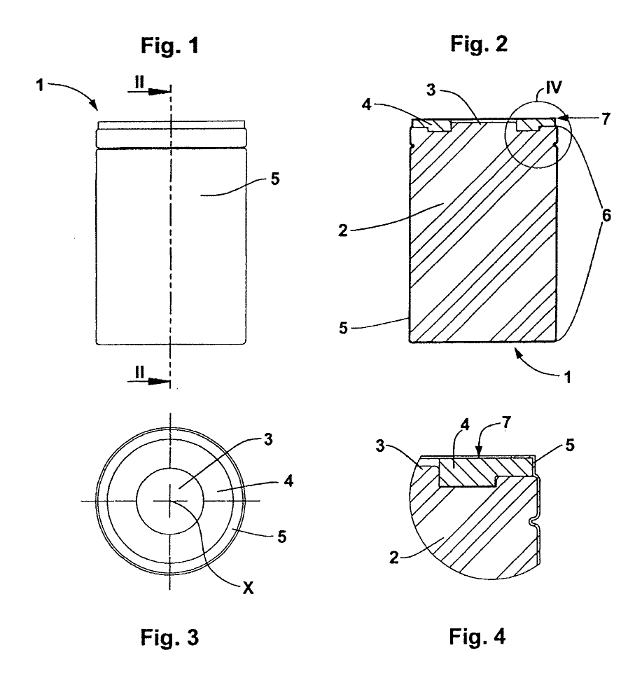

FIG. 1 a side view of a storage battery unit;

FIG. 2 a section along the line II-II in FIG. 1;

FIG. 3 a plan view of the storage battery unit according to FIG. 1;

FIG. 4 a detailed view IV from FIG. 2.

An exemplary embodiment of a storage battery unit 1 according to the invention is shown in FIGS. 1 through 4. The storage battery unit 1 comprises a rotationally symmetrical battery cell 2, embodied in an elongated manner, with a rotation axis that coincides with a longitudinal axis X. The battery cell 2 is delimited by edges 6 and has a freely accessible raised terminal 3. A non-conductive, elastic element 4 of silicone is placed on the battery cell 2 on the terminal side, which element is embodied as a disk with a projection, which engages in a groove running around the terminal 3 in the battery cell 2. The elastic element 4 or the disk is fixed on the battery cell 2 by an outside insulation 5, also enclosing the edges 6 and having a hole on a top and on a bottom. The elastic element 4 is higher than the terminal 3, so that the latter lies below a level 7 of the elastic element 4, and a rotationally symmetrical opening in the elastic element 4 is embodied slightly larger than the terminal 3. Thus the terminal 3 is displaced inwards in the storage battery unit 1. If a storage battery unit 1 of this type is placed in a closeable housing with at least partially rigid contacts, which are located on the base and/or cover, a clamping and fixing can be achieved essentially based on the elastic element 4, which protects the contacts.

The storage battery unit 1 described above is produced in the following steps: The elastic element 4 in the form of a disk of silicone having an opening and a sufficient height is placed on the battery cell 2 so that the opening surrounds the raised terminal 3 of the battery cell 2 and the terminal 3 due to the height of the disk lies below the level 7 of the same. Subsequently, the insulation 5 is applied, for example in the form of a heatshrinking sleeve, which, after heating, fixes the elastic element 4 or the disk on the battery cell 2 and at the same time leaves the terminal 3 on the top of the battery cell 2 and a part of the bottom free.

1. A storage battery unit with a battery cell, having a terminal, with edges and an outside insulation also enclosing the edges, characterized in that a non-conducting, elastic element (4) is positioned on the terminal side between the battery cell and the insulation, so that the terminal is set back with respect to a level of the elastic element, wherein the insulation fixes the elastic element.

2. The storage battery unit according to claim 1, characterized in that the elastic element is composed of elastically deformable plastic.

3. The storage battery unit according to claim 1, characterized in that the elastic element is composed of a silicone.

4. The storage battery unit according to claim 1, characterized in that the battery cell is rotationally symmetrical.

5. The storage battery unit according to claim 4, characterized in that the battery cell is embodied in an elongated manner, and a longitudinal axis coincides with a rotation axis.

6. The storage battery unit according to claim 4, characterized in that the elastic element is rotationally symmetrical.

7. The storage battery unit according to claim 1, characterized in that the terminal of the battery cell is raised and the elastic element is higher than the terminal.

8. The storage battery unit according to claim 1, characterized in that an opening in the elastic element is embodied slightly larger than the terminal.

9. The storage battery unit according to claim 1, characterized in that the elastic element is embodied as a disk.

10. A storage battery set comprising a housing and one or more battery cells, wherein the battery cells are arranged in the housing and at least in part are held in an electric circuit by at least partially rigid contacts arranged on a housing cover and on a housing base, characterized in that the battery cells are respectively part of a storage battery unit according to claim 1.
